(19) United States
(12) Patent Application Publication
(10) Pub. No.: US 2015/0007690 A1
(43) Pub. Date: Jan. 8, 2015

(54) GEARBOX

(71) Applicant: COMER INDUSTRIES S.P.A., Milano (IT)

(72) Inventors: Achille BRUNAZZI, GUALTIERI (IT); Gianni TENCA, VIADANA (IT); Paolo FONTANA, MONTECCHIO EMILIA (IT); Matteo NEGRELLI, CARPI (IT)

(21) Appl. No.: 14/321,546

(22) Filed: Jul. 1, 2014

(30) Foreign Application Priority Data
Jul. 4, 2013 (IT) MO2013A000195

(51) Int. Cl. F16H 57/021

(52) U.S. Cl. CPC F16H 57/021
USPC 74/606 R

(57) ABSTRACT

A gearbox is provided. The gearbox includes two mutually opposite walls and at least one shaft that supports at least one gear, the shaft passing through the gearbox from one of the two mutually opposite walls to the other. Each one of the ends of the shaft is coupled rotatably to a respective wall by a respective bearing. The gearbox also includes at least one rigid tension member, which is internal to the gearbox and acts between the two mutually opposite walls to perform their traction.

### CROSS-REFERENCE TO RELATED APPLICATIONS

This application claims priority to Italian Patent Application No. MO2013A000195 filed on Jul. 4, 2013, the disclosure of which is hereby incorporated in its entirety by reference herein.

### TECHNICAL FIELD

The present invention relates to a gearbox.

### BACKGROUND

A gearbox, or transmission box, is a box that contains internally all the transmission elements required to transfer or convert a torque and a rotation from one or more inputs to one or more outputs. The transmission elements usually comprise rotation shafts, which pass through the transmission box and are coupled rotatably to it by way of bearings of various kinds Gears of various kinds are furthermore associated with the rotation shafts and the torque and rotation are transferred by means of the gears from the input to the output of the transmission box.

By means of the bearings, the loads that act on the transmission elements are transferred to the transmission box. Such loads arise from various contributions and in particular from the external forces that act on the shaft, or arise from the loads generated by the gears or from reactions that are internal to the bearings. This last case is typical of angular contact bearings (of the tapered roller or spherical type). For this type of bearing the working angle of the rolling bodies in fact produces axial thrusts even in the presence of merely radial external stresses.

Such known types of gearbox are not devoid of drawbacks, which include the fact that their external structure is strongly subject to structural tensions and deformations in the presence of the intense loads induced by the active internal rotating components, and often tends to fail structurally.

Another drawback of such known types of gearbox is that especially in the case of large boxes, with very wide walls, i.e., in which the thickness/width ratio is very low, the axial loads are the most critical type of stress, since they can cause large deformations due to the limited stiffness offered by the wall in an axial direction, i.e., at right angles to its surface extension.

Another drawback of such gearboxes of the known type resides in that they require solutions for reinforcing the external structure, such as ribs or increased cross-sections, which entail an increase in the space occupations and weights of the box and in any case have limits to the degree of stiffness that can be given to the box.

Moreover, in the field of motion transmission it is known that preloading angular contact bearings is a practice aimed at limiting the play of the rolling bodies in the operating conditions and at extending the life of the bearings. Preloading is obtained usually by shimming or by using threaded rings that are screwed onto the rotation shafts and move the bearings into abutment against specifically machined locators in seats obtained on the gearbox proper. Such mechanisms for preloading the bearings, however, do not allow precise, quick and convenient adjustment of the preloading of the bearings.

### SUMMARY

The aim of the present invention is to provide a gearbox that solves the technical problem described above, obviates the drawbacks and overcomes the limitations of the background art, by being structurally rigid and not subject to unwanted failures and/or deformations.

Within this aim, an object of the present invention is to provide a gearbox that allows to adjust accurately, precisely, rapidly and also comfortably the preloading of the rotation bearings of the shafts.

Another object of the invention is to provide a gearbox that is capable of giving the greatest assurances of reliability and safety in use.

Another object of the invention is to provide a gearbox that is easy to provide and economically competitive if compared with the background art.

This aim, as well as these objects and others that will become better apparent hereinafter are achieved by a gearbox, comprising two mutually opposite walls and comprising at least one shaft that supports at least one gear, the at least one shaft passing through the gearbox from one of the two mutually opposite walls to the other, each one of the ends of the at least one shaft being coupled rotatably to a respective wall by means of a respective bearing, characterized in that it comprises at least one rigid tension member, which is internal to the gearbox and acts between the two mutually opposite walls to perform their traction.

### BRIEF DESCRIPTION OF THE DRAWINGS

Further characteristics and advantages will become better apparent from the description of a preferred but not exclusive embodiment of a gearbox, illustrated by way of non-limiting example with the aid of the accompanying drawings, wherein:

FIG. 1 is a perspective view of an embodiment of a gearbox according to the invention;

FIG. 2 is a side view of the gearbox of FIG. 1;

FIG. 3 is a sectional view of the gearbox shown in FIG. 2, taken along the plane III-III;

FIG. 4 is a perspective view of some components of the gearbox of FIG. 1, showing in particular a shaft that supports a gear;

FIG. 5 is a perspective view of a component of the gearbox of FIG. 1, showing in particular a tension member;

FIG. 6 is a side view of the tension member shown in FIG. 5.

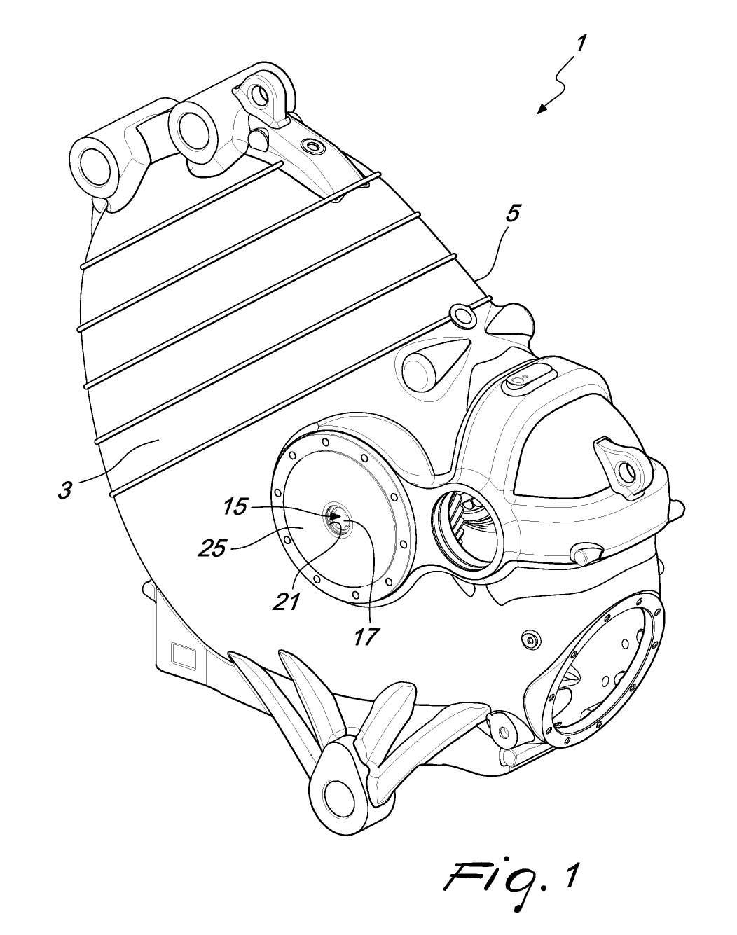

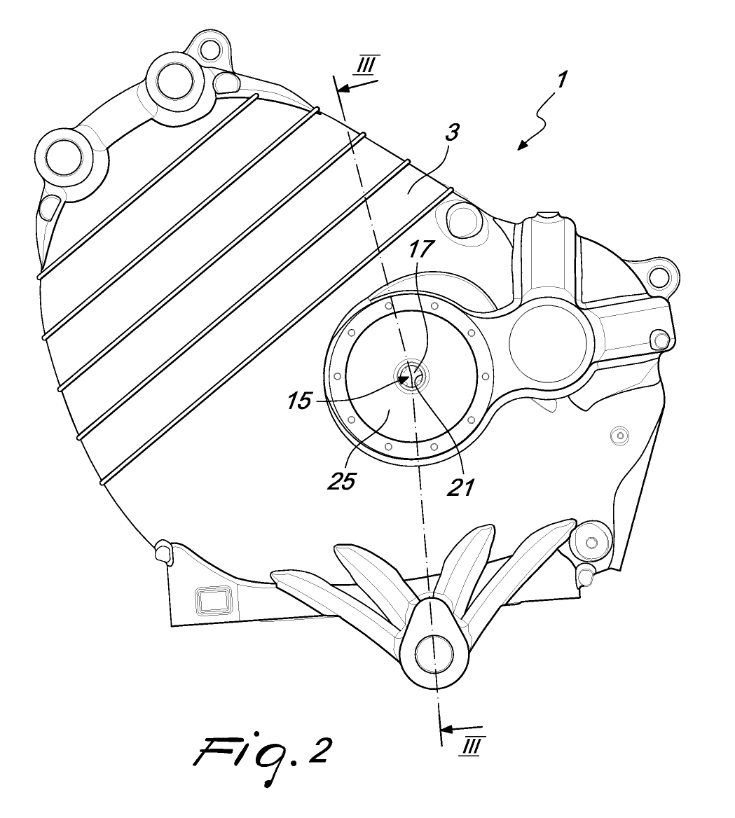

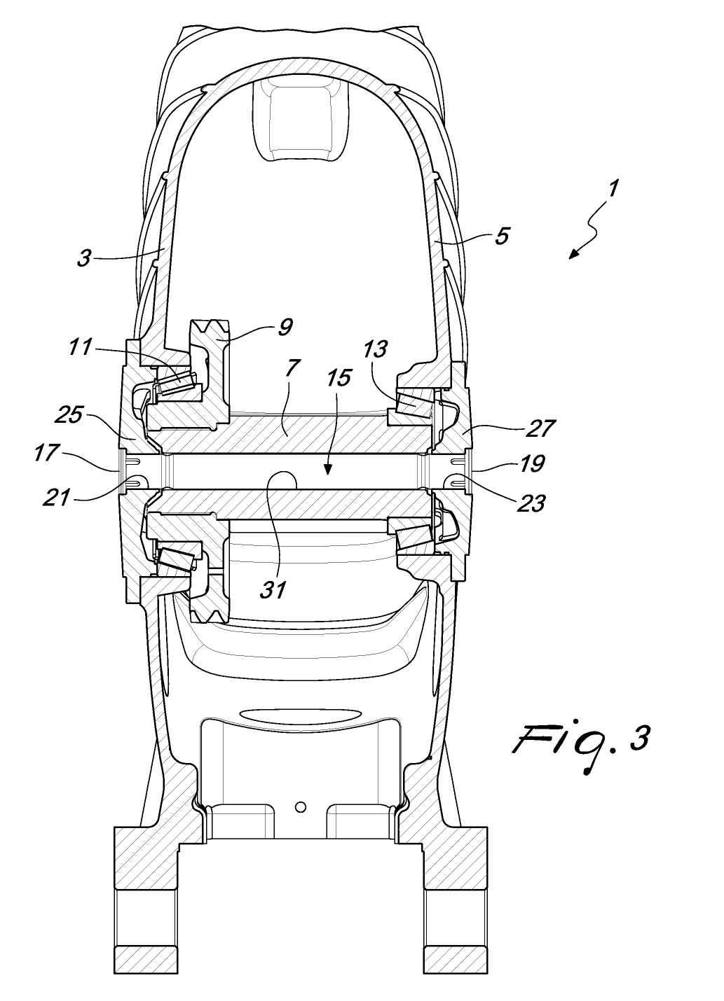

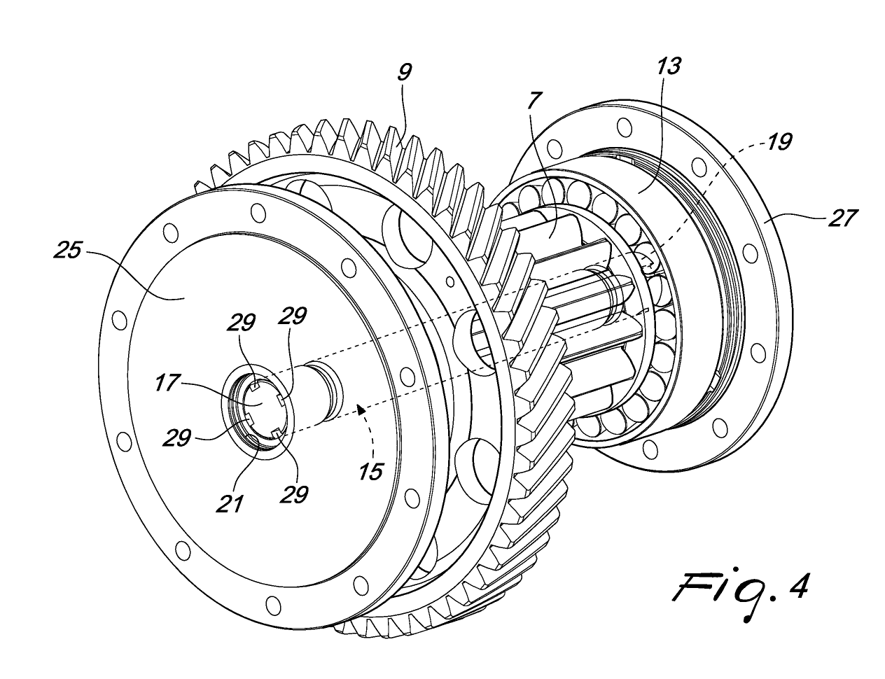

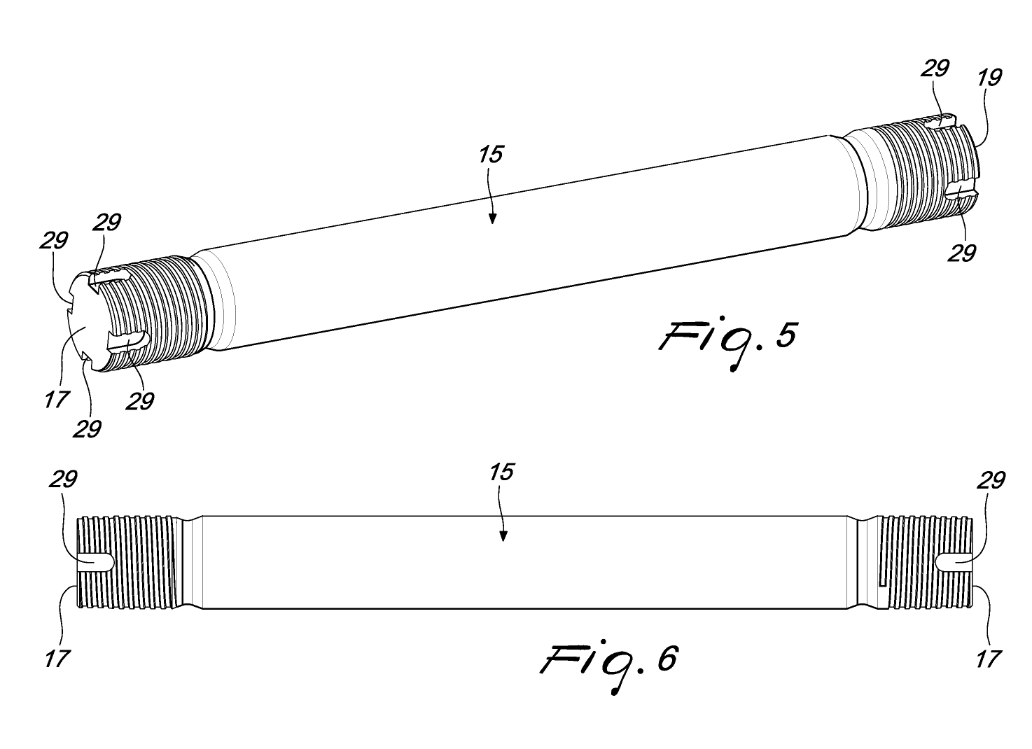

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

With reference to the figures, the gearbox, generally designated by the reference numeral 1, comprises two mutually opposite walls 3 and 5 and comprises at least one shaft 7 that supports at least one gear 9. The shaft 7 passes through the gearbox 1 from one of the two mutually opposite walls 3 and 5 to the other. Each one of the ends of the shaft 7 is coupled rotatably to a respective wall 3 or 5 by means of a respective bearing 11 or 13.

According to the invention, the gearbox 1 comprises at least one rigid tension member 15, which is internal to the gearbox 1 and acts between the two mutually opposite walls 3 and 5 to perform their traction.

The tension member 15 can be coupled directly to the walls 3 and 5 of the gearbox 1.

In particular, the tension member 15 comprises advantageously a substantially cylindrical body provided with two threaded ends 17 and 19, which are adapted to engage in two respective threaded holes 21 and 23, each provided in one of the two walls 3 and 5.

Advantageously, each one of the two walls 3, 5 comprises an opening that can be closed by a respective cover 25 and 27. The two threaded holes 21 and 23 are each provided in a respective cover 25 or 27. The covers 25 and 27 can be fixed to the respective wall 3 or 5 of the gearbox 1 by way of various fixing means, such as for example screws.

The two threaded ends 17 and 19 of the tension member 15 advantageously have threads with opposite orientations. In particular, the two ends 17 and 19 can have threads with a respectively left-handed and right-handed helical path or vice versa.

Moreover, at least one of the two threaded ends 17 or 19 comprises means adapted for the rotation of the tension member 15 with respect to its own longitudinal axis. Such means adapted for the rotation of the tension member 15 can comprise a plurality of recesses 29 provided in at least one of the two ends 17 or 19. The tension member 15 can thus be rotated with respect to its own longitudinal axis, acting, by means of adapted tools of a known type, by action on the recesses 29 provided in at least one of the two ends 17 or 19 of the tension member 15 or, preferably, provided in both ends 17 and 19.

Moreover, the shaft 7 of the gearbox 1 can comprise a longitudinal through hole 31, i.e., a hole provided along the longitudinal axis of rotation of the shaft 7, within which the tension member 15 is accommodated.

The bearings 11 and 13 can be of the type of angular contact bearings, i.e., of the type of tapered roller bearings or of the type of angled spherical bearings; in this manner, the mutual traction between the two walls 3 and 5 by the action of the tension member 15 is capable of preloading the bearings 11 and 13.

In particular, the action of the gear 9, with helical teeth, combined with the adoption of bearings 11 and 13 of the angular contact bearing type, generates, at the seats of the bearings 11 and 13, reactions in an axial direction, i.e., in a longitudinal direction, which are transmitted to the walls 3 and 5 of the gearbox 1. The tension member 15 is adapted, in the presence of the intense axial thrusts generated inside the gearbox 1, to contrast the deformation of the walls 3 and 5, keeping them in mutual traction and contributing to reducing the state of stress of the gearbox 1.

The rotation of the tension member 15 with respect to its own longitudinal axis, thanks to the presence of the two threaded ends 17 and 19, with oppositely oriented threads, allows to introduce and adjust the preloading on the gearbox 1 and thus on the bearings 11 and 13. In fact, the rotation of the tension member 15 in one direction tends to move mutually closer the walls 3 and 5, or the covers 25 and 27, by way of the traction on the threaded holes 21 and 23, inducing a compression load along the longitudinal axis of the tension member 15. This also entails an increase in the extent of the preloading that acts on the angular contact bearings 11 and 13.

Conversely, a rotation of the tension member 15 in the opposite direction tends to move mutually apart the walls 3 and 5, or the covers 25 and 27, by pushing on the threaded holes 21 and 23, inducing a traction load along the longitudinal axis of the tension member 15 and causing a reduction of the extent of the preloading that acts on the angular contact bearings 11 and 13.

In practice it has been found that the gearbox according to the present invention achieves the intended aim and objects, since it allows to introduce a connection between the mutually opposite walls of the box, preventing its failure, or its excessive deformation, especially in the presence of high loads in an axial direction.

Another advantage of the gearbox according to the invention resides in that it reduces the tensions and deformations of the box, causing a stiffening of the overall system. In particular, the cylindrical tension member is more effective than other reinforcement solutions, such as the presence of external ribs or larger cross-sections of the box, since it is far more rigid thanks to the direct transmission of forces. It is in fact known that an axially stressed cylindrical member is far more rigid than a flexurally stressed member, especially if the latter has a very low thickness/surface ratio, as in the case of the walls that delimit a gearbox of the known type.

Another advantage of the gearbox according to the invention resides in that it allows fine adjustment of the preloading of the rotation bearings of the shaft, reducing the risk of preloading loss and thus extending the life of the bearings. Moreover, this adjustment of the preloading of the bearings can be performed comfortably and quickly, simply by rotating the tension member.

Another advantage of the gearbox according to the invention resides in that a single element, i.e., the tension member, performs the dual function of structural reinforcement of the box and of adjustment of the preloading of the bearings.

Moreover, the fact that the tension member can be accommodated axially within the shaft allows to connect structurally the two mutually opposite walls of the box, which support the shaft, in a position that is approximately barycentric with respect to the region of axial thrust of the loads produced by the angular contact bearings, thus optimizing the structural reinforcement function and reducing the presence of shearing stresses on the walls of the box.

The gearbox thus conceived is susceptible of numerous modifications and variations, all of which are within the scope of the appended claims.

All the details may further be replaced with other technically equivalent elements.

In practice, the materials used, so long as they are compatible with the specific use, as well as the contingent shapes and dimensions, may be any according to requirements.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A gearbox, comprising:
two mutually opposite walls and comprising at least one shaft that supports at least one gear, the at least one shaft passing through the gearbox from one of the two mutually opposite walls to the other, each one of the ends of the at least one shaft being coupled rotatably to a respective wall by means of a respective bearing, further comprising at least one rigid tension member, which is internal to the gearbox and acts between the two mutually opposite walls to perform their traction.

2. The gearbox according to claim 1, wherein the tension member comprises a substantially cylindrical body provided with two threaded ends, which are adapted to engage in two respective threaded holes, each provided in one of the two walls.

3. The gearbox according to claim 2, wherein each one of the two walls comprises an opening that can be closed by a respective cover, the two threaded holes being each provided in one of the two covers.

4. The gearbox according to claim 2, wherein the two threaded ends have threads with opposite orientations.

5. The gearbox according to claim 2, wherein at least one of the two threaded ends comprises means adapted for the rotation of the tension member with respect to its own longitudinal axis.

6. The gearbox according to claim 5, wherein the means adapted for the rotation of the tension member comprise a plurality of recesses provided in at least one of the two ends.

7. The gearbox according to claim 1, wherein the at least one shaft comprises a longitudinal through hole, the tension member being accommodated in the through hole.

8. The gearbox according to claim 1, wherein the bearings are of the type of angular contact bearings, the traction of the two walls by the tension member preloading the bearings.
